(19) United States
(12) Patent Application Publication
(10) Pub. No.: US 2005/0127716 A1
(43) Pub. Date: Jun. 16, 2005

(54) Vehicle floor compartments

(75) Inventor: David Gray McLeod, Rochester, MI (US)

Correspondence Address: Richard W. Hoffmann, PO Box 70098, Rochester Hills, MI, 48307, US

(73) Assignee: Dow Global Technologies Inc., Midland, MI (US)

(21) Appl. No.: 11/012,607

(22) Filed: Dec. 15, 2004

Related U.S. Application Data
(60) Provisional application No. 60/529,681, filed on Dec. 15, 2003.

(51) Int. Cl. B62D 25/08

(52) U.S. Cl. 296/203.01

(57) ABSTRACT

A system is described for increasing the interior space of a vehicle. The system includes a modular compartment having a base with at least two sidewalls extending upwardly from the base. The sidewalls preferably connect to a support structure of the vehicle. The base of the compartment preferably extends below the support structure of the vehicle.

### CROSS-REFERENCE TO RELATED APPLICATIONS

This application claims the benefit of U.S. Provisional Application No. 60/529,681, filed Dec. 15, 2003, the disclosure of which is incorporated herein by reference.

### FIELD OF THE INVENTION

The present invention relates generally to storage compartments and more particularly to motor vehicle floor compartments.

### BACKGROUND OF THE INVENTION

In the field of motor vehicle interior design there is a desire to maximize the efficiency of vehicle interior designs. For example, it is desirable to increase space for carrying cargo or to provide additional leg room for the vehicle's occupants.

One way of accomplishing this is to provide seats that fold or collapse to allow clearance for larger, bulkier items to be loaded into the vehicle. However, the seats are often folded in such a manner that they are on top of the interior floor. In this case, the interior dimensions are not maximized because space is lost as a result of the folded seats resting on the vehicle floor.

Another way of maximizing the efficiency of vehicle interior designs relates to the storage of articles. Many vehicles come with devices such as cargo nets or storage compartments that can secure items to prevent them from shifting or rolling about the vehicle during travel. Conventional storage devices are not always practical for articles of various sizes. For example, a cargo net is not practical for securing small loose articles. Likewise a storage compartment is often limited as to the dimensions of the articles it can contain.

Still another way of maximizing the efficiency of vehicle interior designs relates to the position of the driver and passenger seats. The positioning of the seats primarily determines the amount of leg room that the driver and the passengers have in the vehicle. Leg room is generally defined as the amount of volume between adjacent rows of seats (e.g., between the front and rear seat rows) or between the seats and the instrument panel (e.g., when measuring front seat leg room) that a passenger has to place their feet and legs when seated. Generally, the amount of space between seats is a function of several factors that include door placement and the overall dimensions of the passenger cabin.

Typically, many vehicles have relatively flat floor pans with no depressions that allow for the placement of feet and legs. Thus, the efficiency of the vehicle interior design is not optimized. For example, the driver and front seat passengers have more leg room, while the passengers in the second or further rows of seats are more cramped because they have less leg room. The lack of leg room also lessens the amount of space that is permitted for storing items on the floor of the vehicle behind the first and subsequent rows of seats.

Accordingly, there exists a need for a system for increasing the available space within a vehicle interior design, especially for providing increased leg room and cargo storage capacity.

### SUMMARY OF THE INVENTION

In accordance with the general teachings of the present invention, a system for increasing the available space within a vehicle interior design is provided.

In accordance with one embodiment of the present invention, the system preferably includes a modular compartment located within the interior surface of a vehicle. The compartment preferably includes a base with at least two sidewalls extending upwardly from the base. The sidewalls preferably connect to a support structure of the vehicle. The base of the modular compartment preferably extends below the support structure of the vehicle.

In accordance with an alternative embodiment of the present invention, a modular compartment for the interior floor of a vehicle is provided, wherein the vehicle includes a support structure, the compartment comprising: (1) a base; and (2) at least two sidewalls extending upwardly from said base operable to be connected to the vehicle support structure such that the top of said at least two sidewalls are substantially flush with the interior floor of the vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a schematic view of a vehicle incorporating various preferred embodiments of the present invention;

FIG. 2 illustrates a side view of the schematic illustrated in FIG. 1;

FIG. 3 illustrates a cross-sectional view taken along lines 3-3 of FIG. 1; and

FIG. 4 illustrates the same view as FIG. 3 with the additional features of a sound abatement layer and a foot plate.

The same reference numerals refer to the same parts throughout the various Figures.

### DETAILED DESCRIPTION OF THE PREFERRED EMBODIMENTS

The following description of the preferred embodiment(s) is merely exemplary in nature and is in no way intended to limit the invention, its application, or uses.

The present invention primarily comprises a compartment preferably having a base that preferably has at least two sidewalls extending upward from the base. The sidewalls preferably have a flange, or other member, which can be adhesively bonded, or otherwise fastened or connected, to a support structure of a vehicle. Without being bound to a particular theory of the invention, the compartment is intended to increase the storage capacity and/or leg room of the vehicle.

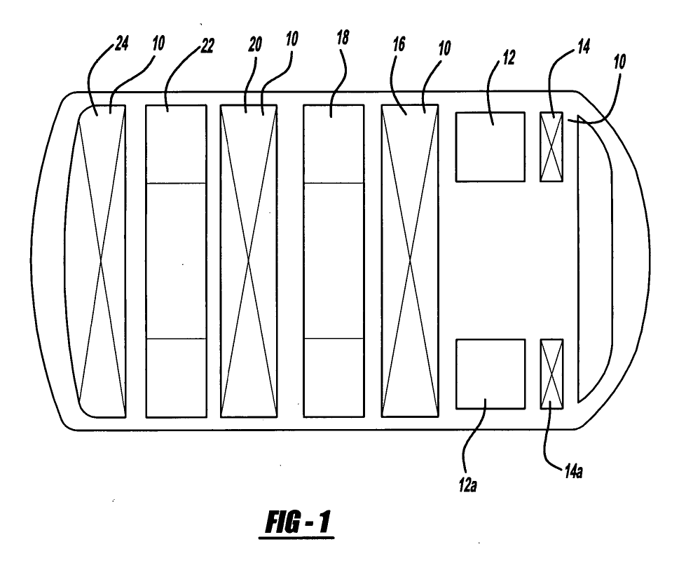

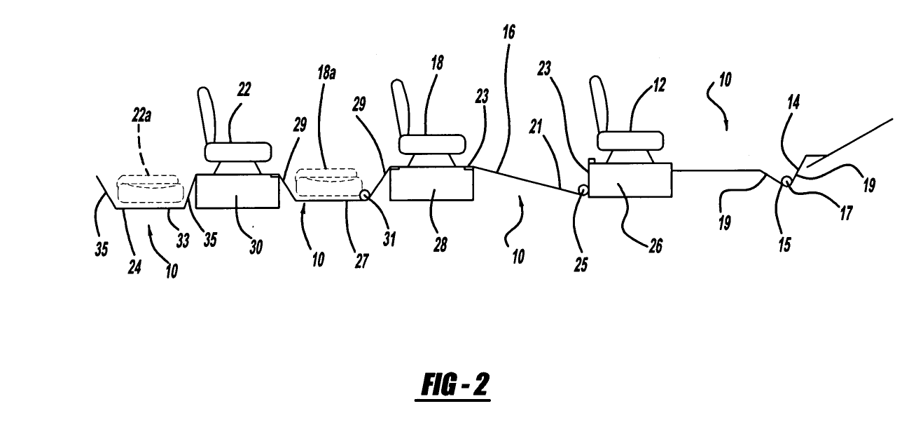

Referring to FIGS. 1 and 2, a vehicle is shown incorporating four presently preferred embodiments of modular compartments 10 of the present invention. Although the vehicle is shown as being configured as a mini-van, it should be appreciated that one or more embodiments of the present invention can be used in any type of vehicle depending on the particular design requirements for the vehicle.

The front seats 12, 12a of the vehicle preferably include a modular compartment 14 located in front of each respective seat. Each modular compartment 14 preferably includes a base 15 with foot plate 17 positioned in the support structure in the interior of the vehicle. The foot plate 17 shall be understood to be that region or area of the compartment 14 upon which the user places their feet or any portion of their feet (i.e., heel point, toe region, etc).

The support structure of the vehicle preferably includes two or more longitudinal beams that that run the length of the interior of the vehicle and two or more lateral cross-bars that attach at a generally perpendicular angle to the longitudinal beams. In a conventional setting, e.g., where the floor of the interior of a vehicle is flat, the support structure is located below the floor covering.

The compartment 14 preferably further includes at least a pair of sidewalls 19 connected to the base 15. The base 15 of the compartment preferably defines the floor of the vehicle. As shown, the base 15 is preferably not planar, but rather it includes a portion of the foot plate 17. The compartment 14 preferably extends below the top surface of the support structure of the vehicle, and enhances or increases the amount of leg room provided by increasing the volume of space that the user has to place their legs and feet.

Between the front seats 12, 12a, respectively, a second modular compartment 16 is preferably provided. The second modular compartment 16 preferably includes a base 21 and at least a pair of sidewalls 23. A footplate 25 may also be located on the base 21. Typically, the foot plate 25 is positioned on the base 21 near the forward sidewall 23. While the base 21 is depicted as having a forwardly sloping structure, it should be appreciated that a structure of any slope (or no slope) is also within the scope of the present invention. The base 21 of the second modular compartment 16, and more specifically the foot plate 25, preferably provides a place for passengers in the second seat 18 to place their feet.

As with the first modular compartment 14, the second modular compartment 16 preferably extends below the upper surface of the support structure of the vehicle. By extending the base 21 below this point of the support structure, interior space in the vehicle is enhanced in the form of increased leg room. It should be appreciated that some applications may require the second modular compartment 16 to have more or less volume in order to provide more storage space or leg room, as the case may be. The second modular compartment 16 can also serve as a storage compartment by placing items therein.

A third modular compartment 20 is preferably located between the second seat 18 and a third seat 22. As with the previously described embodiments (i.e., compartments 14, 16 respectively), the third modular compartment 20 has a base 27 and at least a pair of sidewalls 29 extending upwardly from the base 27. Additionally, the base 27 preferably extends below the upper surface of support structure of the vehicle. The base 27 of the third modular compartment 20 may also have a footplate 31 formed on its surface. The footplate 31 provides a place for passengers in the third seat 22 to place their feet.

The base 27 of the third modular compartment 20 preferably also includes a larger volume than the first and second modular compartments 14, 16, respectively. This greater volume allows for storage of relatively larger items (e.g., luggage) in the third modular compartment 20. Further, it serves as a seat storage compartment wherein the second seat 18 folds backward into the third modular compartment 20. Preferably, the size and depth of the third modular compartment 20 allows the folded vehicle seat 18a (shown in dashed lines) to be flush with the top or upper surface of the support structure of the interior of the vehicle upon which the seats are mounted.

A fourth modular compartment 24 can also be located behind the third seat 22. As with the previously described embodiments (e.g., compartments 14, 16, and 20, respectively), the fourth modular compartment 24 preferably extends below the support structure of the vehicle and includes a base 33 and at least a pair of sidewalls 35 extending upwardly from the base 37.

The fourth modular compartment 24 preferably provides a bin for receiving items (e.g., luggage). By virtue of the configuration of the fourth modular compartment 24, the compartment can receive relatively large items. The fourth modular compartment 24 also preferably has a depth that is sufficient to allow the third seat 22 to fold backwards into the fourth modular compartment 24, so that the folded third seat 22a (shown in dashed lines) will be flush with the top of the support structure of the interior of the vehicle.

Each of the modular compartments of the present invention is preferably formed of a composite material. In a preferred embodiment, the composite materials used include, but are not limited to glass-filled, mineral filled, metal mesh reinforced, or mineral-glass filled combinations of semi-crystalline or amorphous polymers and include, but are not limited to polyamides such as various grades of nylon, various polyolefins, such as but not limited to polyethylene, polypropylene, and the like, syndiotactic vinyl aromatic polymers, such as but not limited to syndiotactic polystyrene (SPS) and any blends thereof. Other potential polymers useful in the practice of the present invention include, but are not limited to polyesters, polyesteramides, polyarylates, polyurethane polyureas, polyphenylene sulfides, polytherimides, and the like. It will be appreciated that other thermoplastic or thermoset composite materials may be used within the scope of the present invention. The compartments of the present invention may also be formed of steel, stainless steel, aluminum or laminates thereof in conjunction with polymeric materials. The metal—polymer composite may be of a sandwich construction of metal-polymer-metal or a polymer laminated on one or both sides of the metal.

Each of the base, sidewalls and foot plates of the compartments of the present invention are preferably integrally formed, such as by injection molding, blow-molding, and the like. It will be appreciated, however, that any number of conventional techniques may be used to integrally form the components.

Referring specifically to FIG. 2, the attachment of each modular compartment to the vehicle's support structure can be seen. The modular compartments 14, 16, 20, 24, respectively, are preferably affixed between a number of cross-bars 26, 28, 30, respectively, on the interior the vehicle.

By way of a non-limiting example, the first modular compartment 14 is affixed between an inclined portion 44 of the front portion of the vehicle interior and a first cross-bar 26, the second modular compartment 16 is located between a first cross-bar 26 and a second cross-bar 28, the third modular compartment 20 is located between the second cross-bar 28 and a third cross-bar 30, and the fourth modular compartment 24 is located between the third cross-bar 30 and a fourth cross bar 45 at the rear of the vehicle.

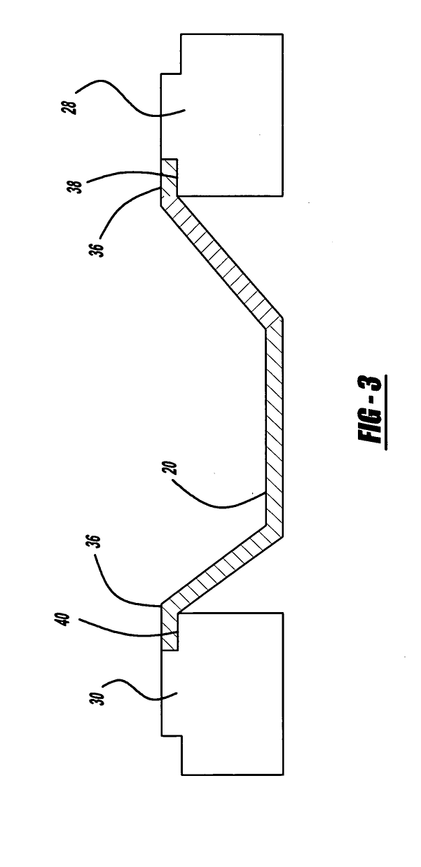

Referring now to FIG. 3, there is shown a cross-sectional view of the third modular compartment 20 affixed between the second cross-bar 28 and the third cross-bar 30. The third modular compartment 20 can also be affixed to the longitudinal rails of the vehicle (not shown). While FIG. 3 depicts the placement of the third modular compartment between two cross-bars, it should be understood that this is generally how the other compartments of the present invention are preferably affixed to the vehicle. Additionally, the other compartments of the present invention can also be fastened to the longitudinal rails (not shown) of the vehicle in a manner similar to the fastening of the compartments of the present invention to the cross-bars described above.

Preferably, a mounting flange 36, or similar member, extends around the entire periphery of the third modular compartment 20. The mounting flange 36 is preferably configured so as to substantially mate with flanges 38, 40 formed on the second cross-bar 28 or the third cross-bar 30, respectively. Additionally, the remaining sides of the mounting flange 36 may also be mated with flanges (not shown) formed on the sides of longitudinal beams (not shown).

The mounting flange 36 is preferably secured to the flanges 38, 40 using suitable adhesives or other conventional methods (e.g., fasteners or a combination of adhesives and fasteners). By way of a non-limiting example, preferred adhesives include, but are not limited to polyurethane adhesives and LES (Low Energy Surface) adhesives, such as alkyl borane amine complex initiated acrylic adhesives. Representative of preferred LES adhesives are described in various patents including U.S. Pat. Nos. 5,106,928, 5,143,884, 5,286,821, 5,310,835, 5,376,746, 5,539,070, 5,690,780 and 5,691,065, the entire specifications of which are incorporated herein by reference.

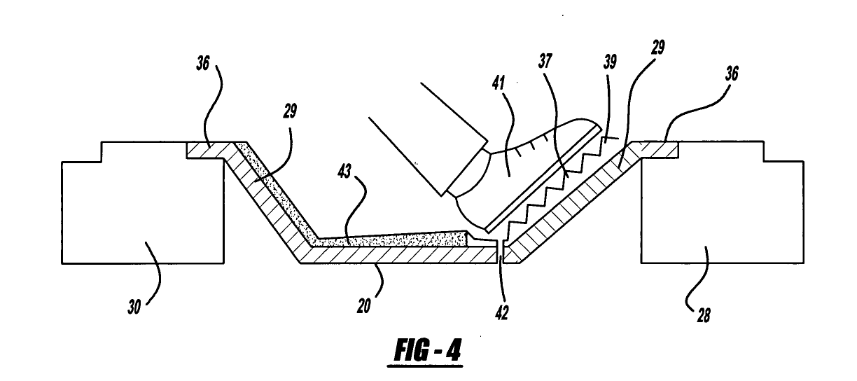

Referring now to FIG. 4, there is shown a cross-sectional view of the third modular compartment 20 equipped with a foot plate 31. This particular embodiment of the present invention includes a foot plate 31 that is located along the surface of one of the sidewalls 29 of the third modular compartment 20. It should be appreciated that it is generally within the scope of this invention to have the foot plate positioned on any surface, or any combination of surfaces, of the modular compartments.

In this embodiment of the present invention, the foot plate 31 preferably includes several lateral convolutions 39 or ribs that are intended to trap moisture. The foot 41 of the passenger preferably rests on the convolutions 39. At the bottom of the convoluted surface 39, a drain hole 42 is preferably provided. The drain hole 42 preferably allows any accumulated moisture to be drained directly out of the vehicle. It is also contemplated that certain embodiments may not use a drain hole, and may instead depend on other methods, such as evaporation, for removing accumulated moisture. Containing and removing moisture reduces damage to objects, such as clothing or packages that may be touching the floor of the interior cabin of the vehicle.

This particular embodiment also preferably includes a base 20 and one sidewall 29 that is lined with a sound abatement layer 43. Each of the modular compartments 14, 16, 20, 24, respectively, may also include a sound abatement layer. Similarly, the sound abatement layer 43 may be secured to one or more of the sidewalls 29.

The sound abatement materials may be molded in placed or foamed in place. Preferably, the noise abatement materials include any adequate foam, filled foam, filled elastomeric sheet, or injection moldable filled material. Additionally, the sound abatement layer may also comprise a layer of carpet that is bonded to the respective compartment.

The foot plate of the first, second and third modular compartments described above serves to provide the driver and passengers with a place to comfortably place or rest their feet, e.g., during travel. Additionally, the increased volume of the compartment with the foot plate provides additional leg room for the vehicle passengers. This allows the driver and passengers to have better leg and foot positioning without having to design a vehicle compartment that is longer and/or wider.

The modular compartments described above offer many advantages over conventional metal automotive floor pans. For instance, they are lighter in weight and less expensive than conventional designs. Additionally, they offer inherent improvements in noise/vibration/harshness (NVH) performance, thermal insulation, molded colors and surface features, dent and ding resistance and corrosion resistance. The modular compartments described above can also be supplied with added functionality: such as carpet, floor mats, and/or NVH materials or attributes. Additionally the modular compartments provide a potential manufacturing advantage as they can used to stow seat assemblies and other parts prior to attachment to the vehicle.

The description of the invention is merely exemplary in nature and, thus, variations that do not depart from the gist of the invention are intended to be within the scope of the invention. Such variations are not to be regarded as a departure from the spirit and scope of the invention.

1. A modular compartment for a vehicle interior comprising:
a base, and at least two sidewalls extending upwardly from said base and connectable to the base of the vehicle support structure so that the top of said at least two sidewalls are flush with a surface of the vehicle interior, wherein said base and said at least two sidewalls define a modular compartment.

2. The modular compartment of claim 1 wherein said surface of the vehicle interior is an interior floor surface and said base is configured to be located below the plane of said interior floor.

3. The modular compartment of claim 1 wherein said modular compartment is located in front of a front seat of a vehicle.

4. The modular compartment of claim 1 wherein said base is non-planar.

5. The modular compartment of claim 1 wherein a portion of said base has a foot plate.

6. The modular compartment of claim 5 wherein said foot plate is adapted to divert moisture to a location where it can be eliminated.

7. The modular compartment of claim 1 wherein said base is planar.

8. The modular compartment of claim 1 wherein said modular compartment is located between a front seat and a second set in a vehicle.

9. The modular compartment of claim 8 wherein said modular compartment is configured to allow items to be stored therein.

10. The modular compartment of claim 1 wherein said modular compartment is located behind a most rearward seat in said vehicle.

11. The modular compartment of claim 10 wherein said modular compartment is configured to allow items to the stored.

12. The modular compartment of claim 10 wherein said modular compartment is adapted to hold a collapsed seat from said vehicle interior such that said seat is disposed in a compartment in a manner that it is flush with said surface of said vehicle interior.

13. The vehicle interior of claim 1 wherein said support structure of said vehicle includes at least two longitudinal beams extending the length of said vehicle interior and at least two lateral cross-bars that attach at a generally perpendicular angle to said longitudinal beams.

14. The modular compartment of claim 13 wherein said at least two side walls of said modular compartment is bonded to at least one of said longitudinal beams on said lateral cross-bars.

15. A modular compartment for a vehicle interior comprising:
a base;
a foot plate adjacent at least a portion of the surface of said base; and
at least two sidewalls extending upwardly from said base and connectable to the base of the vehicle support structure so that the top of said at least two sidewalls are flush with a surface of the vehicle interior, wherein said base, said foot plate and said at least two side walls are integrally formed.

16. The modular compartment of claim 15 wherein said base, said foot plate and said at least two side walls are integrally formed.

17. The modular compartment of claim 15 wherein said base, said foot plate, and said at least two side walls are integrally formed of a composite material.

18. The modular compartment of claim 17 wherein said composite material consists of at least one polymer selected from a group comprising polyamides, polyolefins, syndiotactic vinyl aromatic polymers, polyesters, polyesteramides, polyarylates, polyurethane, polyureas, polyphenylene sulfides, polytherimides and combinations and mixtures thereof.

19. The modular compartment of claim 17 wherein said composite material comprises at least one material selected from a group comprising of glass-filled, mineral filled, metal mesh reinforced and combinations mixtures thereof.

20. The modular compartment of claim 15 wherein said base, said foot plate, and said at least two side walls are integrally formed of metal.

21. A vehicle interior having a modular compartment arrangement comprising:
a first modular compartment located in front of a front seat of a vehicle, said first modular compartment extending below a support structure of a vehicle interior, wherein said first modular compartment has a base and at least two side walls extending upwardly from said base, wherein said at least two side walls are connectable with said support structure;
a second modular compartment located between said first seat and said second seat of a vehicle, said second modular compartment extending below said support structure of said vehicle interior floor, wherein said second modular compartment has a base and at least two side walls extending upwardly from said base and connectable to said support structure.

22. The vehicle interior of claim 21 further comprising a third modular compartment located between said second seat of said vehicle and a third seat of said vehicle, and extending below said support structure of said vehicle interior floor, wherein said third modular compartment has a base and at least two side walls extending upwardly from said base, wherein said at least two side walls are connectable to said support structure, wherein said third modular compartment is adapted to allow said second seat to collapse and be contained within said third modular compartment.

23. The modular compartment of claim 22 wherein said third modular compartment is adapted to contain said collapsed second seat so that the upper portion of said collapsed second seat is flush with said support structure.

24. The vehicle interior of claim 22 further comprising a fourth modular compartment located behind said third seat and extends below said support structure, wherein said fourth modular compartment has a base and at least two side walls extending upwardly from said base, wherein said fourth modular compartment is adapted to allow said third seat to collapse and be contained within said fourth modular compartment.

25. The vehicle interior of claim 24 wherein said fourth modular compartment is adapted to contain said collapsed third seat so that the upper portion of said collapsed third seat will be flush with said support structure.

26. The vehicle interior of claim 25 wherein said fourth modular compartment is a rearward compartment that is always located behind a most rearward seat in said vehicle interior.

27. The vehicle interior of claim 21 wherein said first modular compartment and said second modular compartment include a foot plate contacting at least a portion of said surface of said base and a drain hole is disposed through said foot.
